(19) United States
(12) Patent Application Publication
(10) Pub. No.: US 2016/0338483 A1
(43) Pub. Date: Nov. 24, 2016

(54) DECORATIVE TOOTHBRUSH AND METHOD OF SUPPLYING A DECORATIVE TOOTHBRUSH

(71) Applicant: Joan Marie Eccarius, St. Charles, MO (US)

(72) Inventor: Joan Marie Eccarius, St. Charles, MO (US)

(21) Appl. No.: 14/830,532

(22) Filed: Aug. 19, 2015

Related U.S. Application Data
(60) Provisional application No. 62/164,747, filed on May 21, 2015.

(51) Int. Cl. A46B 15/00; G06Q 30/06

(52) U.S. Cl. CPC A46B 15/0087; A46B 15/0085; G06Q 30/0621

(57) ABSTRACT

A decorative toothbrush and method of supplying a decorative toothbrush is presented wherein a customer can select an image to be printed or otherwise applied to the exterior surface of a toothbrush. This customer selected image can be any image, such as the appearance of stone, wood, glass, tile or metal. Or otherwise, this image can be an image supplied by the customer. This allows a customer to purchase custom-made toothbrushes. This allows for the manufacture of toothbrushes that match and blend in with any bathroom.

### CROSS REFERENCE TO A RELATED APPLICATION

This invention is directed toward a conversion of U.S. Ser. No. 62/164,747 filed May 21, 2015.

### BACKGROUND OF THE INVENTION

This invention relates generally to toothbrushes. More specifically, and without limitation, this invention relates to a decorative toothbrush and method of supplying and manufacturing a decorative toothbrush.

### BRIEF SUMMARY OF THE INVENTION

A decorative toothbrush and method of supplying a decorative toothbrush is presented wherein a customer can select an image to be printed or otherwise applied to the exterior surface of a toothbrush. This customer selected image can be any image, such as the appearance of stone, wood, glass, tile or metal. Or otherwise, this image can be an image supplied by the customer. This allows a customer to purchase custom-made toothbrushes. This allows for the manufacture of toothbrushes that match and blend in with any bathroom.

### BRIEF DESCRIPTION OF THE DRAWINGS

FIG. 1 is a perspective view of a toothbrush and decorative covering;

FIG. 2 is a schematic view of an environment for supplying a decorative toothbrush;

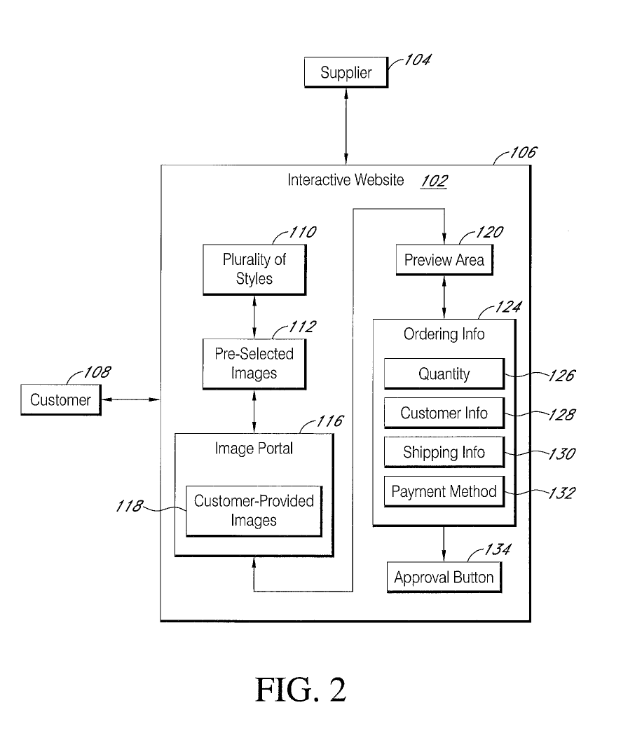

FIG. 3 is a flow diagram of a method of supplying a decorative toothbrush.

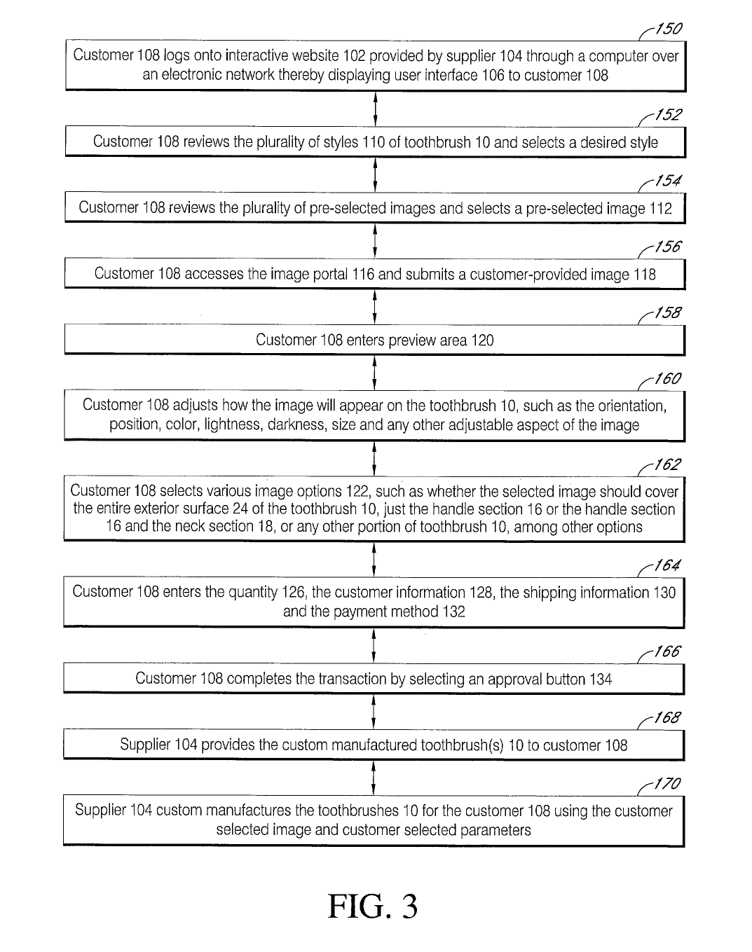

### DETAILED DESCRIPTION OF THE PREFERRED EMBODIMENT

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the invention.

In addition, while the system presented herein is shown and described primarily with a toothbrush, the system is not limited strictly to use with a toothbrush. Instead, reference to a toothbrush is merely one of countless applications. It is hereby contemplated that the system can be used with type of device, especially any type of a device used in a bathroom.

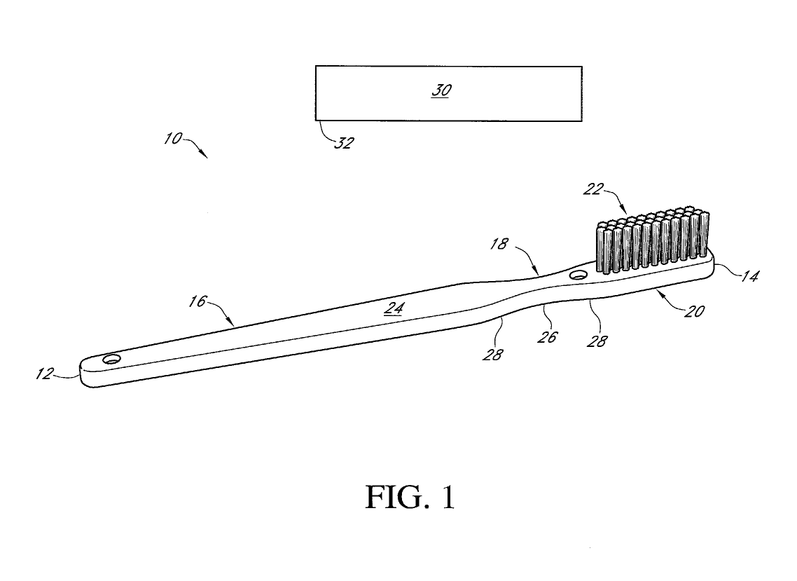

Tooth Brush: With reference to FIG. 1, a toothbrush 10 is presented. In the arrangement shown, toothbrush 10 extends in a generally elongated mariner from a first end 12 to a second end 14 and includes a handle section 16, a neck section 18 and a head section 20 having bristles 22. Toothbrush 10 includes an exterior surface 24 that encompasses the entire exterior surface of the toothbrush 10.

Handle section 16 is formed of any suitable size, shape and design and serves to be grasped and held by a user while brushing their teeth using toothbrush 10. As one example, as is shown, handle section 16 is a generally elongated shape, such as a rectangle, that gets slightly wider as it extends from the first end 12 towards second end 14. Handle section 16 has a rounded first end 12, and rounded corners or edges for user comfort. The forward end, or second end, of handle section connects to the rearward end, or first end of neck section 18. However, any other suitable size, shape and design is hereby contemplated for use for handle section 16.

Neck section 18 connects at its rearward end, or first end, to the forward end, or second end, of handle section 16. Neck section 18 is formed of any suitable size, shape and design and serves to connect handle section 16 to head section 20. In the arrangement shown, as one example, neck section 18 generally narrows or “necks down” at its middle 26, whereas it is wider at its ends 28 where it connects to the end of handle section 16 and head section 20. Neck section 18 narrows or necks down so as to allow greater clearance in a user's mouth and to allow for easier use. This also allows for a wider handle section 16 that allows for better user grasp and manipulation, as well as a wider head section 20 that allows for an adequate amount of bristles 22. Like handle section 16, neck section 18 includes generally rounded edges for user comfort. However, any other suitable size, shape and design is hereby contemplated for use for neck section 18.

Head section 20 connects at its rearward end, or first end, to the forward end, or second end, of neck section 18. Head section 20 is formed of any suitable size, shape and design and serves to hold an effective number of bristles 22 extending outward from its upward facing surface. In the arrangement shown, as one example, head section 20 is generally rectangular in shape and terminates in a rounded end at second end 14. Like handle section 16 and neck section 18, head section 20 includes generally rounded edges for user comfort. However, any other suitable size, shape and design is hereby contemplated for use head section 20.

Any other size, shape and design of a toothbrush 10 is hereby contemplated for use. While the toothbrush 10 shown in FIG. 1 is non-motorized or manual in nature, it is also hereby contemplated that a motorized toothbrush 10 is interchangeable and equally applicable.

Motorized toothbrushes include, but are not limited to, electric toothbrushes that oscillate or rotate such as power toothbrushes, sonic toothbrushes, ultrasonic toothbrushes or the like. The toothbrush also is made of any material such as metal, bone, wood, plastic, cardboard, glass, tile or the like and any combination of materials.

Printing Method: Conventional toothbrushes 10 are generally formed of a single color, or a plurality of colors. These colors tend to be bright or neon colors. While these bright or neon colors may be pleasing to children, these bright or neon colors cause toothbrush 10 to stick-out or clash with the design of many bathrooms, especially high-end bathrooms that are formed of tile, stone, wood, metal or any combination, pattern or mosaic of these materials.

To obviate this visual clashing, the exterior surface 24 of toothbrush 10 is covered with an ornamental covering or layer or coating 30 (hereinafter “ornamental coating”). Ornamental coating 30 is any form of a coating or layer or coloring placed on the exterior surface 24 of toothbrush 10 and serves to improve its visual appearance. Ornamental coating 30 can be applied to exterior surface 24 of toothbrush 10 by any manner or method or means.

In one arrangement, ornamental coating 30 is applied by the method screen printing. Screen printing is a technique whereby a mesh and blocking stencil is used to transfer ink onto a substrate, except in areas made impermeable to the ink by the blocking stencil. Ink is transferred to the substrate by forcing it through the mesh opening by a blade or squeegee. As the screen rebounds away from the substrate the ink remains on the substrate. It is also known as silk-screen, screen, serigraphy, and serigraph printing. One color is printed at a time, so several screens can be used to produce multicolored images or designs.

In another arrangement, ornamental coating 30 is applied by printing ornamental coating 30 on a film 32 (also known as a transfer paper) and then adhering film 32 to the exterior surface 24 of toothbrush 10. In this arrangement, film 32 is any form of a thin flexible film that can be adhered or welded or connected to the exterior surface of toothbrush 10 by any manner or means or method. In one arrangement, film 32 is a flexible plastic film that is glued or melted or heat-transferred onto exterior surface 24. In this arrangement, ornamental coating 30 is applied to film 32 by any manner, method or means, such as screen printing, digital printing, or any other form of printing or forming. Once applied, the film 32 and ornamental coating 30 become unitary with the toothbrush 10. To improve adhesion between film 32 and toothbrush 10 a layer of adhesive, such as glue or the like, is used thereby bonding the film 32 to the toothbrush 10.

In another arrangement, ornamental coating 30 is applied by printing ornamental coating 30 on a film 32 and then shrink-wrapping and adhering film 32 to the exterior surface 24 of toothbrush 10. In this arrangement, film is any form of a heat-reactive flexible film that can be adhered to or shrink-wrapped to the exterior surface of toothbrush 10. Once shrink-wrapped to the exterior surface of toothbrush 10, film 32 and ornamental coating 30 become unitary with the toothbrush 10. To improve adhesion between film 32 and toothbrush 10 a layer of adhesive, such as glue or the like, is used bonding the film 32 to the toothbrush 10.

In another arrangement, ornamental coating 30 is applied directly to the exterior surface 24 of toothbrush 10 by printing through a method known as pad or tampo printing, which is a form of indirect gravure printing. In this arrangement, the image to be printed is defined with a metal printing plate or cliché, which is charged with ink. A soft silicone pad is then pressed into the cliché, taking up ink, and then pressed onto the object to transfer the image. Because of the softness of the pad, this method is able to tolerate a considerable degree of non-flatness in the printed product while still giving a good quality print.

In another arrangement, ornamental coating 30 is applied directly to the exterior surface 24 of toothbrush 10 by eleetrophotographic technology (laser printing), inkjet printing or printing by any other manner, method or means. To print directly onto the three-dimensional exterior surface 24 of toothbrush 10, a printer capable of printing on three-dimensional surfaces is employed. In one arrangement, the print heads of the printer are moved over the exterior surface 24 (or alternatively the toothbrush 10 is moved under the print heads), so that a path following the shape of the object is traced out. In one arrangement a robot motion system is employed to move the print heads or the toothbrush 10 to accomplish printing on the three-dimensional surface. This arrangement provides the advantage of accuracy and repeatability as well as allowing different colors to be aligned, and for multiple print swathes to be aligned as well as low set-up investment and time.

In another arrangement, ornamental coating 30 is printed on the exterior surface 24 of toothbrush 10 by a process known as hydro-dipping, hydrographics or HydroGraphics, immersion printing, water transfer printing, water transfer imaging or cubic printing, among other names (hereinafter hydro-dipping). Hydro-dipping is a method of applying printed designs to three-dimensional surfaces using the benefits of a floating film and the natural phenomenon of flowing fluids. The hydro-dipping process can be used on metal, plastic, glass, hard woods, and various other materials. To hydro-dip toothbrush 10, the exterior surface 24 is pre-treated and a base coat material is applied to the exterior surface 24. Next, ornamental coating 30 is printed on film 32. In one arrangement, film 32 includes a polyvinyl alcohol film with the ornamental coating 30 to be transferred onto toothbrush 10. Next, the film 100 is floated on the surface of a tank of water or other fluid. Next, an activator chemical is sprayed on the film 32 to dissolve it into a liquid and activate a bonding agent on the film 32, such as an adhesive. The toothbrush 10 is then lowered into the tank through the floating layer of ink or ornamental coating 30. The ink layer or ornamental coating 30 along with the polyvinyl alcohol backing then wraps around and adheres to the exterior surface 24 of toothbrush 10. The adhesion is a result of the chemical components of the activator softening the base coat layer and allowing the ink of ornamental coating 30 to form a bond with it. Once dipped, the toothbrush 10 is removed from the tank. After removing the toothbrush 10 from the water, a top coat is applied to protect the ornamental coating 30, to increase durability and increase longevity. This process allows multiple colors and intense details to be quickly and easily applied to the exterior surface 24 of toothbrush 10 in a single step. This process allows full 360° coverage of the entire exterior surface 24 of toothbrush 10, including small crevices.

In an alternative arrangement, ornamental coating 30 is applied by spray coating, or by any other manner, method or means that provides the desired ornamental appearance.

Printing ornamental coating 30 on a film 32 allows for producing the ornamental coating 30 in large quantities on rolls of film 32. As film 32 is printed with ornamental coating 30 while the film 32 is flat, this allows for use of less-sophisticated equipment for printing. However, this process creates substantial challenges when transferring the film 32 onto toothbrush 10.

In one arrangement, the ornamental coating 30 is applied to the entire exterior surface 24 of toothbrush 10. In another arrangement, the ornamental coating 30 is not applied to the head section 20, and instead is applied only to the handle section 16 and the neck section 18. In another arrangement, the ornamental coating 30 is not applied to the head section 20 or the neck section 18, and instead is applied only to the handle section 16. In one arrangement, the underlying material of toothbrush 10 is clear such that the places where the ornamental coating 30 is not present blends in with its surrounding environment.

Method of Providing: Bathrooms are formed of countless styles, designs, colors, patterns and materials. As such, to match or blend in with these bathrooms a countless array of toothbrushes 10 are needed to match or blend in with these bathrooms. Accordingly, a method of supplying a custom toothbrush 10 is presented. This method is formed of the following steps and components.

An interactive website 102 is presented by a supplier 104 of custom manufactured toothbrushes 10.

At this interactive website 102 a user interface 106 is presented where a customer 108 can select from a plurality of styles 110 of toothbrushes 10. That is, toothbrushes 10 of different physical designs, sizes, shapes, motorized, or non-motorized are presented for selection by the customer 106.

At this interactive website 102, customer 108 is also presented with a plurality of pre-selected images 112. These pre-selected images 112 can he a catalogue of countless images or designs of common materials used in bathrooms, such as pictures or images of: stone, wood, glass, metal, tile or the like, or any patterns or designs.

More specifically, the types of stone can include: different kinds of marbles, granites, sand stones, travertines, slates, onyx, quartz, fabricated stone, natural stone, stone combinations, stone mosaics and patterns of stone, and any other type of stone or combination thereof or the like.

More specifically, the types of wood can include: different kinds of oaks, birches, maples, pines, bamboos, weathered woods, bleached woods, stained wood, wood grains, exotic woods, laminates, wood combinations, wood mosaics and patterns of wood, and any other type of wood or combination thereof or the like.

More specifically, the types of glass can include: different kinds of transparent glass, opaque glass, colored glass, clear glass, smooth glass, frosted glass, glass with undulating surfaces, glass mosaics, and patterns of glass, and any other type of glass or combination thereof or the like.

More specifically, the types of metal can include: different kinds of brass, copper, bronze, pewter, gold, silver, chrome, stainless steel, nickel, bronze, any of these metals in “antique” or “weathered” form, any combinations of these metals, metal mosaics and patterns of metal, and any other type of metal or combination thereof or the like.

More specifically, the types of tile can include: square tile, rectangular tile, tile mosaics, and tiles having any ornamental appearance, and combinations thereof or the like.

If customer 108 sees a preselected ornamental appearance 112 that meets their needs, the customer 108 selects the desired preselected ornamental appearance 112.

If, on the other hand, the customer 108 is unable to find a preselected ornamental appearance 112 that meets their approval and would produce a toothbrush 10 that matches or blends in with their bathroom, interactive website 102 includes an image portal 116 where customer 108 can download a customer-provided image 118. Customer-provided image 118 is any image that customer 108 selects that customer 108 believes would produce a toothbrush 10 that would match or blend in with their bathroom. Or, alternatively, the customer-provided image 118 is any other image the customer 108 desires. This customer-provided image 118 can be an image customer 108 retrieved from the internet, or other sources. Or, this customer-provided image 118 can be an image customer 108 took of the tile, wood, countertop or other surface in their bathroom or any other surface the customer 108 desires. Or, this customer-provided image 118 can be any other image the customer 108 selects, such as a picture of their child, a picture of their pet, a picture of a landscape, or a picture of anything else they desire.

Once the customer-provided imago 118 is selected, the customer-provided image 118 is downloaded to the image portal 116.

Next, the customer is presented with a preview area 120 where the customer is presented with a preview of what the selected toothbrush 10 will appear like with the selected image thereon. This preview area 120 allows the user to adjust how the selected image will appear on the toothbrush 10, such as the orientation, position, color, lightness, darkness, size and any other adjustable aspect of the image. At the preview area 120, the customer 108 is also presented with a plurality of image options 122, such as Whether the selected image should cover the entire exterior surface 24 of the toothbrush 10, just the handle section 16 or the handle section 16 and the neck section 18, or any other portion of toothbrush 10, among other options.

Once the customer 108 approves the image on the toothbrush 10, the customer 108 is presented with the ordering information section 124. At the ordering information section 124, the customer 108 enters the quantity 126 they desire to purchase, the customer information 128, shipping information 130 and the payment method 132. Once the ordering information is entered, the customer 108 completes the transaction by selecting an approval button 134.

Once the approval button 132 is selected, the supplier 104 custom manufactures the toothbrushes 10 for the customer 108 using the customer selected image and customer selected parameters.

The method of supplying a custom manufactured toothbrush 10 is as follows:

At step 150, customer 108 logs onto interactive website 102 provided by supplier 104 through a computer over an electronic network thereby displaying user interface 106 to customer 108.

At step 152, customer 108 reviews the plurality of styles 110 of toothbrush 10 and selects a desired style through user interface 106.

At step 154, customer 108 reviews the plurality of pre-selected images 112. If the customer 108 finds a pre-selected image 112 that meets their approval, customer 108 selects the pre-selected image 112.

Alternatively, at step 156, if customer 108 was not able to find a pre-selected ornamental appearance 112 that met with their approval, the customer accesses the image portal 116 and downloads or submits a customer-provided image 118 through user interface 106 to interactive website 102. This customer-provided image 118 is any image the customer provides to interactive website 102 such as an image taken by customer 108, or an image retrieved by customer 108 from the internet, a catalog or any other source.

Once the desired image has been selected, either by utilizing a pre-selected image 112 or a customer-provided image 118, at step 158, customer 108 is presented with the preview area 120 of interactive website 102 where customer 108 is provided with a preview of the selected image on the selected toothbrush 10.

At step 160, customer 108 adjusts how the image will appear on the toothbrush 10, such as the orientation, position, color, lightness, darkness, size and any other adjustable aspect of the image.

At step 162, customer 108 selects various image options 122, such as whether the selected image should cover the entire exterior surface 24 of the toothbrush 10, just the handle section 16 or the handle section 16 and the neck section 18, or any other portion of toothbrush 10, among other options.

Once customer 108 approves the image on the toothbrush 10, at step 164 customer 108 is presented with the ordering information section 124 where customer 108 enters the quantity 126 they desire to purchase, the customer information 128, the shipping information 130 and the payment method 132.

Once the ordering information section 124 is complete, at step 166, customer 108 completes the transaction by selecting an approval button 134.

Once the approval button 132 has been selected, at step 168, the supplier 104 custom manufactures the toothbrushes 10 for the customer 108 using the customer selected image and customer selected parameters.

At step 170, supplier 104 provides the custom manufactured toothbrush(s) 10 to customer 108.

Accordingly, from the above discussion it will be appreciated that the decorative toothbrush and method for supplying a decorative toothbrush presented herein improves upon the present state of the art; provides an aesthetically pleasing toothbrush; provides a toothbrush that blends into high-end bathrooms; matches the design of bathrooms; can be custom made to fit the aesthetic appearance of a bathroom; can be made of any color, texture style or design; can be made to match any color, texture, style or design; can have the appearance of wood, stone, tile, metal, or any mosaic or combination or pattern thereof, is easy to use; is simple to use is relatively inexpensive; allows a user style a toothbrush after a user-selected picture; has a high-quality image thereon; has a long useful life; is durable; has an elegant design; can be designed for any bathroom; does an adequate job of cleaning teeth; provides a toothbrush that a user can store on the countertop; provides a toothbrush as beautiful as the rest of the bathroom; among countless other improvements and advantages.

It will be appreciated by those skilled in the art that other various modifications could be made to the device without parting from the spirit and scope of this invention. All such modifications and changes fall within the scope of the claims and are intended to be covered thereby.

What is claimed is:

1. A decorative toothbrush, comprising:
a handle section;
a neck section connected to the handle section;
a head section connected to the neck section;
bristles extending outward from the head section;
the handle section, neck section and head section having an exterior surface;
an ornamental coating covering the exterior surface; and
Wherein the ornamental coating has an appearance selected from the group consisting of: stone, wood, glass, metal and tile.

2. A method of supplying a decorative toothbrush, comprising the steps of:
providing an in interactive website by a toothbrush supplier;
selecting an ornamental appearance for a toothbrush by a customer on the interactive website;
manufacturing a toothbrush having the customer selected ornamental appearance; and
supplying the toothbrush having the customer selected ornamental appearance to the customer by the supplier.

3. The method of claim 2 wherein the ornamental coating has an appearance selected from the group consisting of: stone, wood, glass, metal and tile.

4. The method of claim 2 wherein the ornamental coating has an appearance of a picture supplied by the customer.

5. A method of producing a toothbrush having a decorative coating, consisting of the steps of:
selecting a toothbrush;
selecting an ornamental appearance;
selecting an ornamental coating for the toothbrush based upon the selected ornamental appearance; and
applying the ornamental coating to an exterior surface of the toothbrush.

6. The method of claim 5 wherein the step of applying includes a hydro-dipping process.

7. The method of claim 5 wherein the step of applying utilizes a process selected from a group consisting of screen printing, film transfer, shrink wrapping, tapo printing, laser printing, and spray coating.
